(19) United States
(12) Patent Application Publication
(10) Pub. No.: US 2006/0107508 A1
(43) Pub. Date: May 25, 2006

(54) Method and device for producing a connecting area on a production part

(75) Inventors: Marcus Bonse, Stuttgart (DE); Thomas Kolb, Holzheim (DE); Frank Ostertag, Sindelfingen (DE); Enrico Philipp, Stuttgart (DE); Thomas Stahs, Ulm (DE); Heiko Thaler, Sindelfingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler A G, Stuttgart (DE)

(21) Appl. No.: 10/527,724

(22) PCT Filed: Sep. 6, 2003
(86) PCT No.: PCT/EP03/09919

§ 371 Date: Sep. 9, 2005

(30) Foreign Application Priority Data
Sep. 13, 2002 (DE) 102 42 710.0

(51) Int. Cl. B23Q 17/00; B23P 21/00

(52) U.S. Cl. 29/407.1; 29/407.05; 29/407.09; 29/705

(57) ABSTRACT

A method for producing a connection area (4) on a work piece (1), in particular on a vehicle body plate which is to be positioned precisely with respect to a reference area (8) on the work piece (1). A robot-guided processing tool (9) is used which is permanently connected to a sensor system (13) and forms a tool/sensor combination (16) with it. In a first step, the tool/sensor combination (16) is moved, within the scope of a positioning phase (II), from a proximity position (24) which is independent of the position of the work piece (1) in the working space (23) of the robot (11), into a preliminary position (18) in which the tool/sensor combination (16) is oriented precisely with respect to the reference area (8) of the work piece (1). To move to the preliminary position (18), an iterative closed-loop control process is run through, in the course of which firstly an (actual) measured value of the sensor system (13) is generated and compared with a (setpoint) measured value generated within the scope of a setup phase. A movement vector of the tool/sensor combination (16) is calculated from the difference between the (actual) measured value and (setpoint) measured value using a Jacobi matrix which is calculated within the scope of the setup phase, and the tool/sensor combination (16) is moved by an amount equal to this movement vector. To carry out this positioning task it is possible to dispense with a metric calibration of the tool/sensor combination (16).

The invention relates to a method for producing a connection area on a work piece which is positioned precisely with respect to a reference area on the work piece, according to the preamble of patent claim 1. The invention also relates to a device for carrying out the method.

Connection elements to which add-on parts are attached during the assembly of a vehicle are provided on vehicle bodies in different vehicle body areas during the body shell and/or assembly phases. In the interest of a high quality appearance of the vehicle body it is often necessary to orient and to position these add-on parts in a highly precise fashion with respect to reference areas on the vehicle body or with respect to other modules. In order to be able to ensure highly precise orientation of the add-on parts on the vehicle body, the connection elements must be positioned precisely with respect to the reference areas on the vehicle body.

For example, the tail lights on the vehicle body must be oriented highly precisely with respect to the vehicle body faces which are adjacent to the light in order to bring about buckle-free mirror lines and uniform gap dimensions and junctions in the rear side area of the vehicle body. Each of these tail lights is attached to the vehicle body using a plurality of screws (for example four). In order therefore to bring about highly precise positioning of the tail light in its receptacle on the vehicle body, the corresponding connection areas must be provided in the vehicle body in such a way that highly precise orientation of the tail light with respect to these reference areas (which are adjacent to the tail light) is ensured.

In large-scale series fabrication the connection areas, which are typically composed of a bulge, stamped into the vehicle body part, as a stop face and a hole, punched into this bulge, for the attachment screw to pass through, are generally provided in the vehicle body using a robot-guided stamping and punching tool. The vehicle bodies are fed to the tool on a conveyor belt, for which reason variations in position of the vehicle body with respect to the robot-guided tool occur. Furthermore, the vehicle bodies have, owing to fabrication-related tolerances, deviations from the setpoint shape which is predefined, for example, by a computer-internal (CAD) model. In order to be able to ensure highly precise orientation of the tail light with respect to the reference areas on the vehicle body, there is therefore a need for a method which can be used to orient and position the robot-guided tool in a highly precise fashion with respect to the relevant reference areas of this vehicle body, independently of the shape and spatial position of the respective vehicle body in the working area of the robot, and which method also permits the connection areas to be provided, by controlled processing, in the spatial position which is defined by these reference areas.

DE 299 18 486 U1 discloses a method for the precisely positioned formation of a connection area on a vehicle body component using a robot-guided stamping and punching tool. In this method, a plurality of measured values of the vehicle body component are firstly recorded using a (for example optical) sensor system, and on the basis of these measured values the absolute position of the fed-in vehicle body component is determined in the working space of the robot. Furthermore, the measured values are compared with an “ideal model”, stored in the open-loop control system of the robot, of the area to be processed, and the “ideal model” is moved inside the computer until a maximum overlap between the contours of the “ideal model” and the (actual) contour which is determined by means of measuring equipment occurs. The robot-guided stamping and punching tool is then moved under the control of the robot along a programmed path with respect to the vehicle body, in the course of which the connection points are provided in the vehicle body.

The method which is known from DE 299 18 486 U1 is based on the measurement of the absolute position of the vehicle body in the working space of the robot. For this purpose, in order to apply this method successfully a number of peripheral conditions have to be fulfilled:
The sensor system must firstly be capable of determining individual measured values metrically with respect to its internal reference coordinate system (“internal metric calibration of the sensor system”).
The position of the sensor system in the working space of the robot must also be known (“external metric calibration of the sensor system”).
Finally the sensor system must be capable of combining and compressing a plurality of individual measurements of the vehicle body in such a way that the precise position of a work piece with respect to the working space of the robot can be calculated in a consistent way by controlled processing.
   The setup and calibration work for the sensors and for the entire system in order to fulfil these peripheral conditions has been found empirically to be very high and can only be carried out by experts. Furthermore, the precision and reproducibility of the measured values which is required here can be achieved only by means of high quality (and therefore expensive) sensors.

Furthermore, the evaluation method on which DE 299 18 486 U1 is based resorts, for the determination of the position of the vehicle body, to geometric model knowledge about the respective vehicle body areas (the abovementioned “ideal model”, for example the CAD model of the vehicle body). In order to avoid systematic errors in such a context, a uniquely defined assignment between the measurement features and the model knowledge must be ensured; this is generally associated with a high degree of additional algorithmic work for the respective application.

A further disadvantage of the method known from DE 299 18 486 U1 is that the feature measurements are carried out only once per processing step. Slight movement of the vehicle body during the positioning or processing preparations gives rise to large errors and must therefore be prevented.

The invention is therefore based on the object of proposing a method for producing connection areas on a work piece, in particular on a vehicle body, in a precisely positioned fashion, which method is associated with a significantly reduced degree of calibration work and permits significantly more cost-effective sensors to be used. In addition, the intention is to increase the accuracy in comparison with conventional methods. The invention is also based on the object of proposing a device which is suitable for carrying out the method.

The object is achieved according to the invention by means of the features of claims 1 and 8.

According to said claims, a sensor system which is permanently connected to the tool and forms a robot-guided tool/sensor combination with it is used to position the processing tool with respect to the vehicle body. This tool/sensor combination is firstly moved under robot control into a proximity position (which is permanently programmed and independent of the current position of the vehicle body) with respect to the vehicle body and is then moved, in the course of a closed-loop control process, into a preliminary position (oriented with respect to the reference area on the vehicle body in a precisely positioned fashion). In the closed-loop control process which moves the tool/sensor combination from the proximity position into the preliminary position, (actual) measured values of the reference area are generated on the vehicle body by the sensor system; these (actual) measured values are compared with (setpoint) measured values which are generated in a preceding setup phase, and then the tool/sensor combination is moved by an amount equal to a movement vector (comprising linear movement and/or rotations) which is calculated using what is referred to as a “Jacobi matrix” (or “sensitivity matrix”) from the difference between the (actual) and (setpoint) measured values. Both the (setpoint) measured values and the Jacobi matrix are determined within the scope of a setup phase, preceding the actual positioning and processing operations, for the respective tool/sensor combination together with the vehicle body area to be processed. This setup phase is run through once in the course of the setting of a new combination of tool, sensor system, vehicle body type and processing problem.

When the closed-loop control process is finished and the tool/sensor combination is thus in the desired preliminary position with respect to the vehicle body, the actual processing of the vehicle body takes place. In this context, a predefined processing program for forming the connection areas is run through under the control of a robot, the preliminary position which is found in the course of the positioning being used as the reference position for said program.

The closed-loop control process, in the scope of which the tool is moved from the proximity position (moved under robot control) into the preliminary position (oriented in a precisely positioned fashion with respect to the tool) differs basically from the positioning process which is known from DE 299 18 486 U1; while, in the method in DE 299 18 486 U1, the absolute position of the tool in the working space of the robot, which forms the basis for the further orientation of the tool, is actually determined in the course of the positioning process, the method according to the invention is based on relative measurements, in the course of which information relating to the closed-loop control process is to be restored, said information having been stored in the course of the setup phase and corresponding to a set of (setpoint) measured values of the sensor system.

This gives rise to two significant simplifications compared to the prior art:
on the one hand, internal metric calibration of the sensors is no longer necessary since the sensors which are used no longer “measure” but merely react to a monotonous incremental movement of the robot with a monotonous change in its sensor signal. This means, for example, that when a CCD camera is used as the sensor, the camera-internal lens distortions do not have to be compensated and that when a triangulation sensor is used the precise metric calculation of distance values is dispensed with.
furthermore, external metric calibration of the sensors is no longer necessary: in contrast to the prior art, the position of the sensors no longer needs to be determined with respect to the working space of the robot or the coordinate system of the robot's hand in order to be able to calculate suitable correction movements. The sensors merely have to be attached to the tool in such a way that they are at all capable of sensing suitable measured data of the reference area of the vehicle body in their capture range.

When the method according to the invention is used, it is thus possible to dispense completely with the metric measuring function which can be determined only with great difficulty. For this reason it is also possible to use metrically noncalibrated sensors which are significantly simpler and thus also cheaper than calibrated sensors. Both the design of the instrumentation and the installation and the operation of the entire system can therefore be implemented significantly more cost-effectively when the method according to the invention is used. The means for evaluating the sensor data is very simple and robust, in particular when triangulation sensors which measure at points are used. Furthermore, when the method according to the invention is used, the initial installation and maintenance of the tool is greatly simplified and can also be performed by trained personnel.

The result of the positioning of the tools is also independent of the absolute positioning accuracy of the robot used, since possible robot inaccuracies when moving to the target position are also compensated. Owing to the resulting short error chains it is possible, where necessary, to achieve a very high repetition accuracy in the positioning result.

The number of degrees of freedom of positioning which can be compensated with the method according to the invention in the positioning phase is freely selectable and depends only on the configuration of the sensor system. Likewise, the number of sensors used can be freely selected. The number of (scalar) sensor information items made available merely has to be equal to or greater than the number of degrees of freedom to be controlled. In particular, a relatively large number of sensors may be provided and the redundant sensor information can be used, for example, to be able to sense shaping errors of the vehicle body area under consideration or to improve the positioning process in terms of its accuracy. Finally, sensor information from different sources can be used, (for example a combination of CCD cameras and distance sensors or a combination of distance sensors and force/torque sensors).

The method according to the invention can very easily be adapted to new problems since only the means of acquiring and conditioning the sensor data has to be adapted and not the controlling system core. It is possible to dispense with using model knowledge about the vehicle body areas to be processed, model knowledge playing a decisive role in the calculation of the absolute position in the method in DE 299 18 486 U1.

In comparison with the method known from DE 299 18 486 U1, the method according to the invention permits significantly faster compensation of residual insecurities which may occur during the positioning of the tool with respect to the vehicle body owing to position errors of the vehicle body with respect to the tool which are due to conveying equipment and/or owing to shaping errors within the reference area on the vehicle body itself (as a result of component tolerances). Owing to the high-speed control of the position of the tool with respect to the work piece, the work piece does not need to be clamped in a fixed fashion during the positioning and processing operation but rather can be moved with respect to the robot (for example on an assembly line or some other suitable conveying equipment). This permits a high degree of flexibility of the method according to the invention, which can be applied both to very different application cases of processing and/or measuring fixed and moving work pieces.

The controlled movement to the preliminary position can be carried out in a single control loop, but an iterative method is advantageously used here, threshold values being predefined as abort criteria in said method and in this way the iteration process is aborted if the deviation between the (setpoint) measured value and the (actual) measured value lies below a predefined threshold value; furthermore, the iteration process is aborted if the reduction, which can be achieved during successive iteration steps, in the deviation between the (setpoint) measured value and (actual) measured value lies below a further predefined threshold value.

The positioning of the tool/sensor combination and the processing of the vehicle body by the tool can either be carried out in a sequential succession or else in an overlapping fashion. As a result, when the method according to the invention is used, the position errors and shaping errors of the vehicle bodies before or during the processing can be easily compensated.

The method can thus also be used when processing moving vehicle bodies. However, in this case the sensor system has to be arranged in the tool/sensor combination with respect to the tool in such a way that the sensor system is also oriented with respect to the reference area on the vehicle body during the processing phase in such a way that usable (actual) measured values can be recorded.

Further advantageous embodiments of the invention can be found in the subclaims. The invention is explained in more detail below with reference to two exemplary embodiments which are illustrated in the drawings, in which:

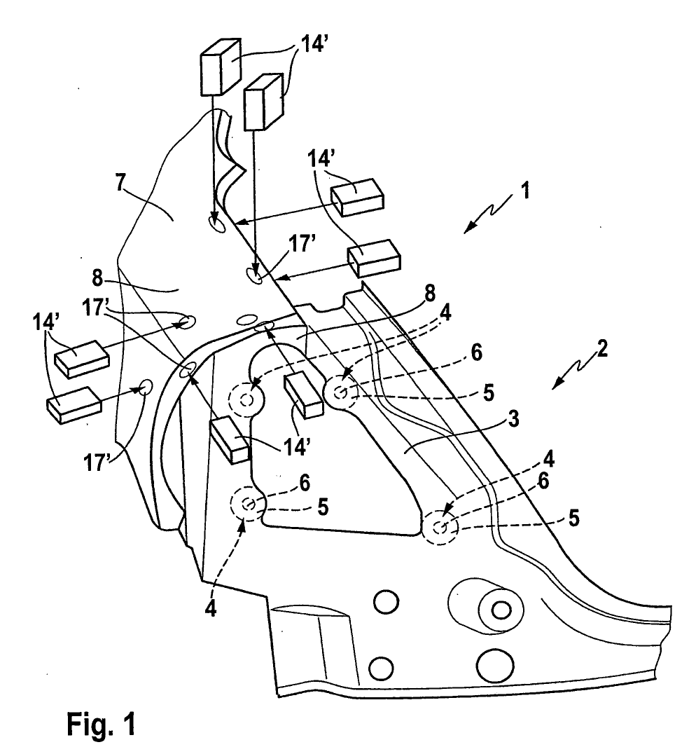

FIG. 1 shows a rear portion of a vehicle body in a perspective illustration,

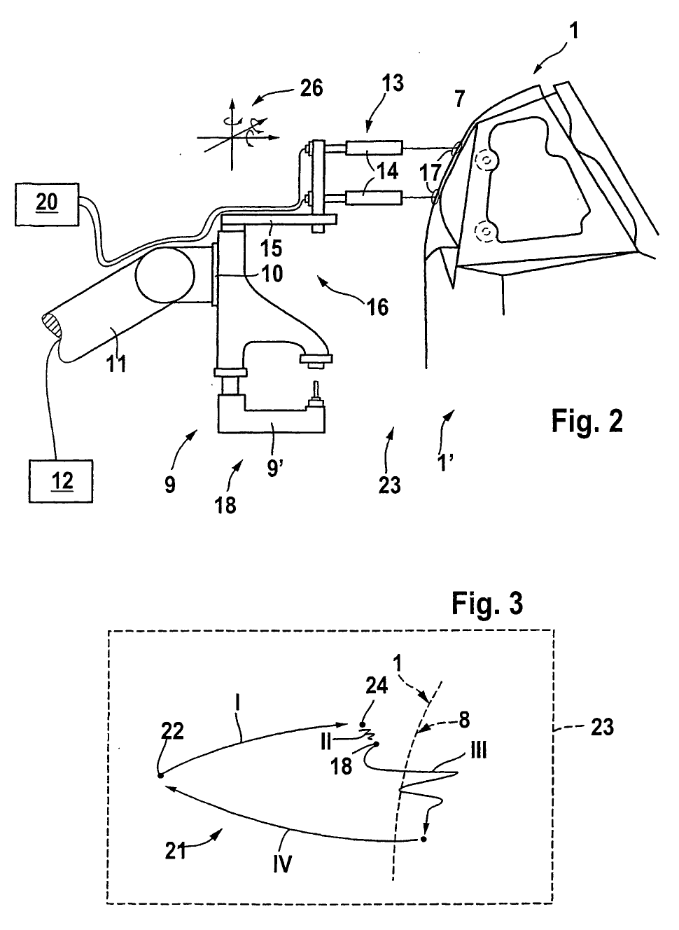

FIG. 2 shows a schematic side view of a vehicle/sensor combination in a preliminary position with respect to the vehicle body,

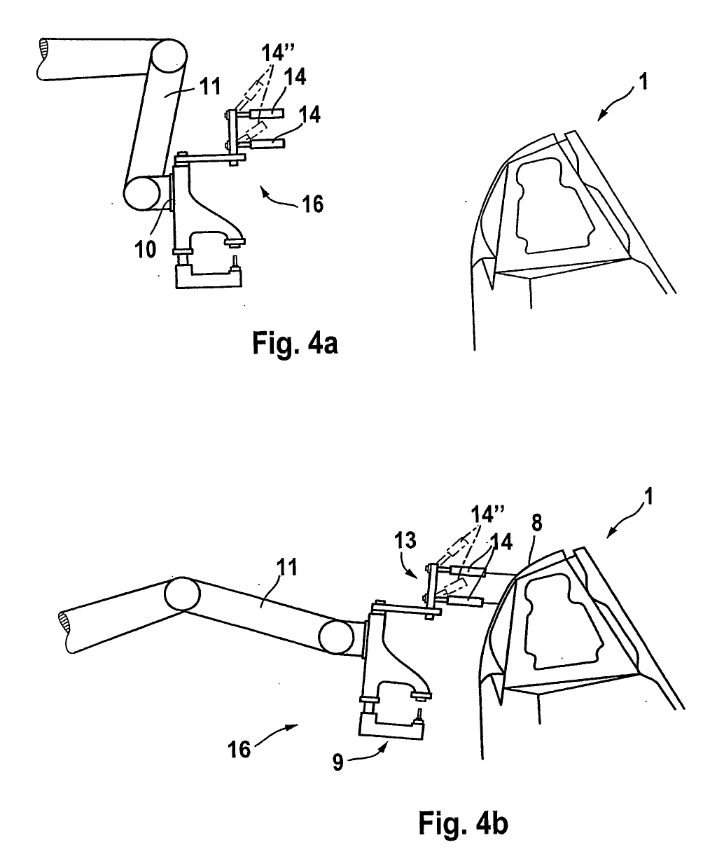

FIG. 3 shows a schematic illustration of a movement path of a robot's hand when the processing task is being executed,

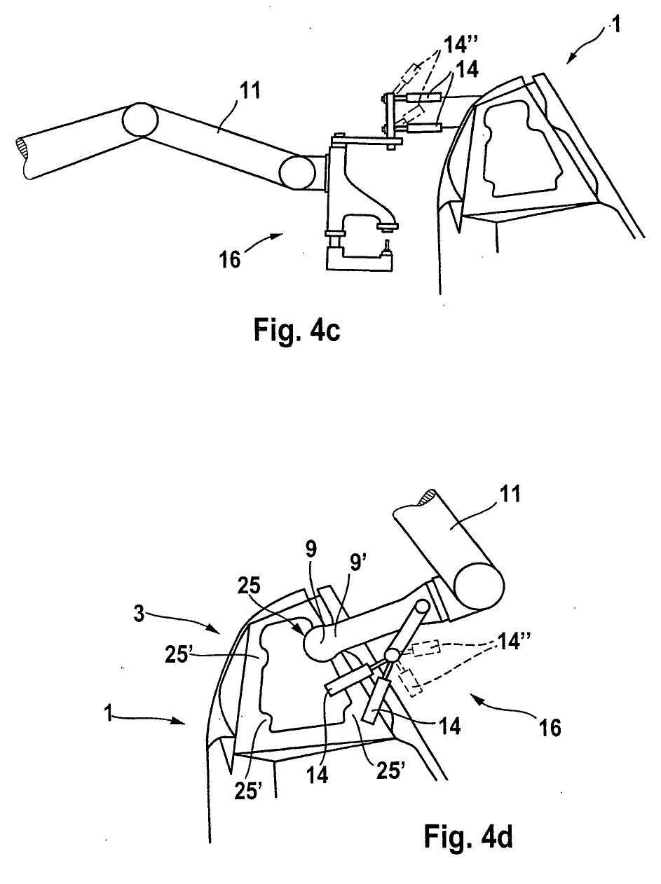

FIG. 4 shows a schematic illustration of selected positions of the tool/sensor combination when the method sequence in FIG. 3 is being run through:

1. FIG. 4a: return movement position

2. FIG. 4b: proximity position

3. FIG. 4c: preliminary position

4. FIG. 4d: processing position

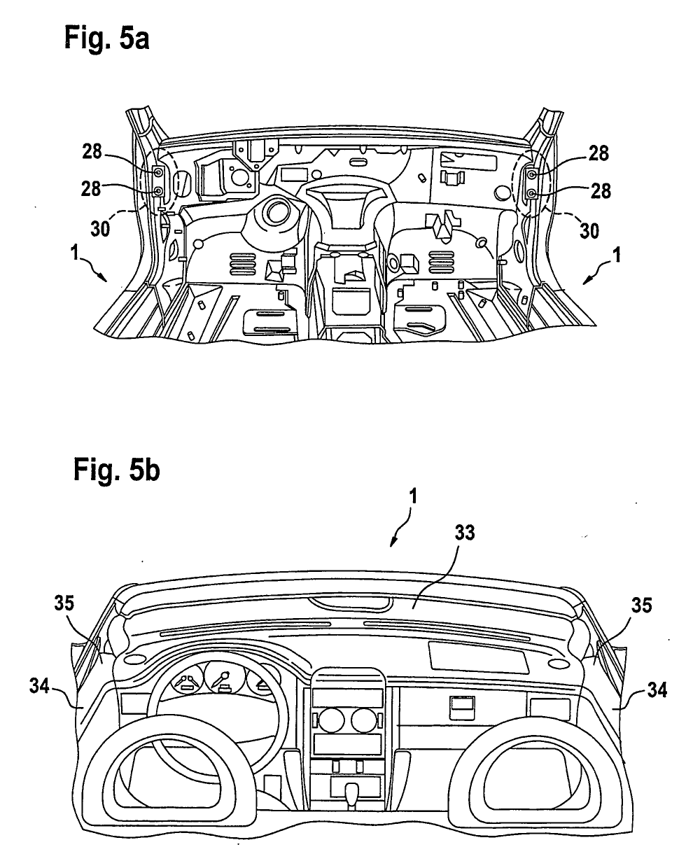

FIG. 5 shows a plan view of a front end wall of a vehicle body . . .

1. FIG. 5a . . . before installation of a cockpit module,

2. FIG. 5b . . . with an installed cockpit module, and

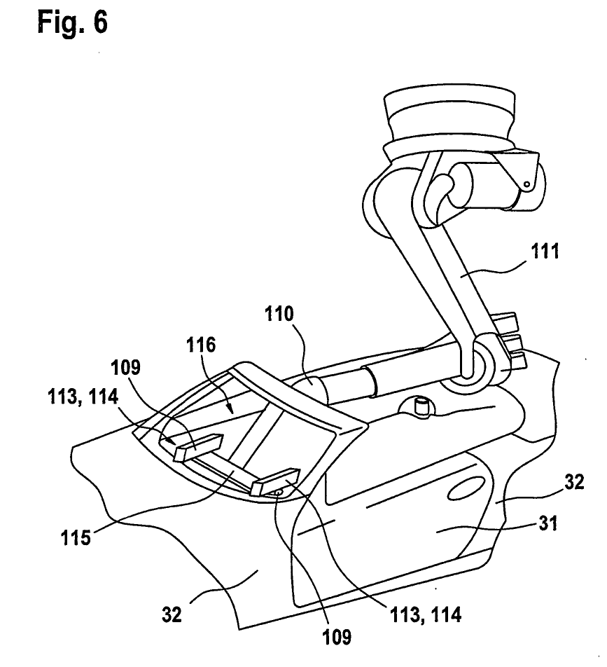

FIG. 6 shows a schematic illustration of a robot-guided tool/sensor combination when the vehicle body area in FIG. 5a is being processed.

FIG. 1 shows a rear portion 2 of a body shell vehicle body 1 with a tail light area 3 in which a tail light (not shown in FIG. 1) is to be mounted. In order to mount the tail light in a precisely positioned fashion, four connection areas 4 (indicated by dashed lines in FIG. 1), to which the tail light is to be attached by screwed connections, are provided in the tail light area 3. Each connecting area 4 comprises a stamped stop face 5 against which the tail light rests in the installed state and a punched hole 6 for an attachment screw to pass through. The relative position of the four stop faces 5 and of the four holes 6 is defined by the geometry of the tail light to be installed and is therefore constant (for a predefined vehicle body type).

In order to ensure a high quality visual impression of the vehicle body 1 the tail light must be oriented in a precisely positioned fashion (in terms of position and angular attitude) with respect to a side wall area 7, adjacent to the tail light area 3, of the vehicle body 1; this means that the four connection areas 4 (each composed of a stop face 5 and a punched hole 6) have to be positioned with high precision with respect to this side wall area 7 and the tail light area 3. The side wall area 7 and the tail light area 3 thus form together what is referred to as a reference area 8 for orienting the tool 9 with respect to the vehicle body 1.

In order to produce the connection areas 4, a robot-guided stamping/punching tool 9 (illustrated schematically in FIG. 2) with a stamping/punching pince 9′ is used and by means of the latter the connection area 4 (i.e. stop face 6) can be generated in a single method step; details relating to the design and the method of operation of such a stamping/punching tool 9 are described, for example, in DE 299 18 486 U1. This stamping/punching tool 9 is attached to the hand 10 of an industrial robot 11 which is provided with an open-loop control device 12 for controlling the position of the robot's hand 10 and for controlling the movement of the stamping/punching tool 9. In order to measure the position and orientation of the tail light area 3 and of the adjacent side wall areas 7, the robot's hand 10 is also fitted with a sensor system 13 with a plurality of sensors 14 (two in the schematic illustration in FIG. 2) which are rigidly connected to the stamping/punching tool 9 via a linkage 15, and thus form one structural unit, referred to as the tool/sensor combination 16, with the tool 9. This sensor system 13 is used, as described below, to orient the stamping/punching tool 9 in an iterative closed-loop control process with respect to the side wall area 7 and the tail light area 3 as reference areas 8.

If the stamping/punching tool 9 is to be set to a new processing task, for example the processing of a new type of vehicle or of a new area on the vehicle body 1, what is referred to as a setup phase must firstly be run through, in which phase a suitable sensor system 13 is selected and configured with the tool 9 to form a tool/sensor combination 16. After this, (setpoint) measured values of this sensor system 13 are recorded in the reference areas 8. After the setup phase has finished, the tool/sensor combination 16 which is configured and calibrated in this way is then ready for series production use in which what is referred to as a working phase is run through for each vehicle body 1 fed to the working space 23 of the robot 11. These two different phases are represented below:

Setup Phase:

In order to carry out a newly set processing task, firstly a sensor system 13 which is adapted to the processing task is selected in a first step. This sensor system 13 is attached to the robot's hand 10 in a (freely selected) preliminary position 18 of the tool/sensor combination, and oriented with respect to a C “master”) vehicle body 1′ in the working space 23 of the robot 11 in such a way that the sensors 14 are directed towards suitable reference areas 8′ of the vehicle body 1′ which are adapted to the respective processing task.

The tool/sensor combination 16 is shown in the preliminary position 18 with respect to the vehicle body 1′ in FIG. 2. The two sensors 14 are directed here towards portions 17 of the reference area 8′ on the vehicle body 1′ which are selected in such a way that they are particularly important for the position and orientation of the areas to be processed with the tool 9. In this specific exemplary embodiment of the processing of the tail light area 3 (FIG. 1), an assembly of eight optical (triangulation) sensors 14′ is used as the sensor system 13, said optical sensors 14′ being directed towards different portions 17′ of the rear side wall 7 and of the tail light area 3. The sensors 14, 14′ supply measured values which correspond to distance values between the respective individual sensor 14, 14′ and the surroundings 17, 17′, lying opposite the sensor 14, 14′, of the reference area 8. The number of individual sensors 14, 14′ and the surroundings 17, 17′ towards which they are directed are selected in such a way that they permit the best possible characterization of the reference areas 8′ (in this case of the rear side wall 7 and the tail light area 3) which are relevant for the respective application case.

The sensor system 13 which is rigidly connected to the tool 9 is then “trained” to the reference area 8′ of the vehicle body 1′ in this preliminary position 18 using the robot 11. In this context, the (setpoint) sensor measured values are firstly recorded in the preliminary position 18. Then, starting from the preliminary position 18, the position of the tool/sensor combination 16 with respect to the vehicle body 1 is systematically changed along known movement paths, as indicated by arrows 26 in FIG. 2, using the robot 11; these are generally incremental movements of the robot 11 in its degrees of freedom. The changes which occur in the process to the measured values of the sensors 14 are recorded (completely or partially). What is referred to as a Jacobi matrix (sensitivity matrix), which describes the relationship between the incremental movements of the robot 11 and the changes which occur in the process to the sensor measured values, is calculated from this sensor information in a known fashion. The method for determining the Jacobi matrix is described, for example, in “A tutorial on visual servo control” by S. Hutchinson, G. Hager and P. Corke, IEEE Transactions on Robotics and automation 12(5), October 1996, pages 651-670. The requirements which are made of the movement paths or the measuring environments (constancy, monotony, . . . ) which have to be fulfilled in order to obtain a valid Jacobi matrix are also described in this article.

The tool 9 is fastened to the robot's hand 10 in such a way that collisions cannot occur between the tool 9 and the vehicle body 1 during this setup process.

The setpoint values which are generated in the setup phase and the Jacobi matrix are stored in an evaluation unit 20 of the sensor system 13 and form the basis for the later closed-loop control process in the positioning phase.

Furthermore, in the setup phase, a movement path 21 of the robot's hand 10 (and thus of the tool/sensor combination 16), which is later run through in a controlled fashion in the later working phase, is generated. This movement path 21 is illustrated schematically in FIG. 3. The starting point of the movement path 21 is formed by what is referred to as a “return movement position” 22 which is selected in such a way that a new vehicle body 1 can be introduced into the working space 23 of the robot 11 without collisions being able to occur between the vehicle body 1 and the tool 9 or the sensor system 13. Starting from this return movement position 22, the movement path 21 comprises four separate sections:
I. The tool/sensor combination 16 is moved, on a path I to be run through in an open-loop controlled fashion, from the return movement position 22 into what is referred to as a “proximity position” 24 which is selected in such a way that all the individual sensors 14 of the sensor system 13 can sense valid measured values in the portions 17 of the reference area 8.
II. The tool/sensor combination 16 is moved, on a path II to be run through in a closed-loop controlled fashion, from the proximity position 24 into the preliminary position 18 (“trained” as described above) in which the tool/sensor combination 16 is oriented in a precisely positioned and angled fashion with respect to the reference area 8 of the vehicle body 1.
III. The tool/sensor combination 16 is guided on a path III, to be run through in an open-loop controlled fashion, from the preliminary position 18 to those processing areas (for example locations 4 of the tail light area 3) at which the connection points 4 are generated. At each connection point 4, the stamping/punching pince 9′ is actuated in order to stamp a stop face 5 and punch a hole 6 in this position. This part III of the movement path can be trained, for example, on a master part by a teach-in method.
IV. The tool/sensor combination 16 is moved back into the return movement position 22 in an open-loop controlled fashion on a path IV.

The movement path 21 which is generated within the scope of the setup phase is thus composed of three sections I, III and IV which are to be run through in an open-loop controlled fashion and a section II which is to be run through in a closed-loop controlled fashion.

Working Phase

In the working phase, vehicle bodies 1 are fed sequentially to the working space 23 of the robot 11, and the movement path 21 which is generated in the setup phase is run through for each vehicle body 1.

Movement Path Section I:

While the new vehicle body I is being fed in, the tool/sensor combination 16 is located in the return movement position 22 (see FIG. 4a). As soon as the new vehicle body 1 has been moved into the working space 23, the tool/sensor combination 16 on the robot's hand 10 is moved into the proximity position 24 in an open-loop controlled fashion (see FIG. 4b).

Movement Path Section II (Positioning Phase):

Starting from the proximity position 24, a positioning phase (path section II in FIG. 3) is run through, in the scope of which the tool/sensor combination 16 is moved into the preliminary position 18 (trained during the training phase) with respect to the vehicle body 1 and in the process is oriented in a precisely positioned fashion with respect to the reference area 8 of the vehicle body 1. For this purpose, measured values of the reference area 8 are recorded by means of the sensors 14 of the sensor system 13. A movement increment (movement vector) which reduces the difference between the current (actual) sensor measured values and the (setpoint) sensor measured values is calculated using these measured values and the Jacobi matrix known from the setup phase. The tool/sensor combination 16 is then moved and/or pivoted by this movement increment using the robot 11, and new (actual) sensor measured values are recorded during the ongoing movement.

This iterative measuring and movement process is repeated in a control loop until the difference between the current (actual) and the aimed-at (setpoint) sensor measured values drops below a predefined fault measure, or until this difference no longer changes beyond a threshold value which is specified in advance. The tool/sensor combination 16 is then in the preliminary position 18 (illustrated in FIG. 4c) with respect to the reference area 8 on the vehicle body 1 (within the scope of the accuracy predefined by the fault measure or threshold value).

Both inaccuracies in the vehicle body 1 in terms of its position and orientation in the working space 23 of the robot 11 and possibly present shaping errors of the vehicle body 1 (or in the reference area 8) are compensated simultaneously by the iterative minimization which is run through in the positioning phase. In order to detect and evaluate shaping errors separately it is possible to provide additional sensors 14 whose measured values are used exclusively or partially for sensing the shaping errors. Furthermore, the measured values of the initial sensors 14 may be provided with different weighting factors in order to optimize the position of the tool/sensor combination 16 with respect to the reference area 8 of the vehicle body 1 in a weighted fashion.

The movement of the position and angle of the tool/sensor combination 16 (corresponding to the movement between the proximity position 24 and the preliminary position 18) which has taken place within the scope of the closed-loop control process of the positioning phase may be passed onto the control system 12 of the robot 11 in the form of what is referred to as a zero point correction. The control system 12 of the robot 11 thus knows the starting position (corresponding to the preliminary position 18) from where the processing phase is to begin. An important property of this positioning phase is its independence of the accuracy of the robot: since the positioning process is based on an iterative comparison between the (actual) measured values and (setpoint) measured values, any positioning inaccuracy of the robot 11 is compensated immediately by the iterative closed-loop control process.

(NB: if the reference area 8 of the vehicle body 1 which is located in the working space 23 of the robot 11 corresponds in terms of position and shape to the reference area 8′ of the (“master”) vehicle body 1′, with reference to which the system was trained in the setup phase, the proximity position 24 corresponds to the preliminary position 18 so that there is no need for a zero point correction of the tool/sensor combination 16.)

Movement Path Section III (Processing Phase):

In the actual processing phase which now follows, the tool/sensor combination 16 is moved, starting from the preliminary position 18, along the pre-programmed processing path (path section III in FIG. 3) in an open-loop controlled fashion. In the present exemplary embodiment, the tool/sensor combination 16 is firstly moved into such a position that the stamping/punching pince 9′ comes to rest in a first processing point 25 of the tail light area 3 (see FIG. 4d). The stamping/punching pince 9′ is then activated in an open-loop controlled fashion so that the stop face 5 is formed and the hole 6 is punched. The three further processing points 25′ of the tail light area 3 are then moved to in succession and provided with stop faces 5 and punched holes 6.

Movement Path Section IV:

After the processing phase III has finished, the tool/sensor combination 16 is moved back into the return movement position 22 in an open-loop controlled fashion. The processed vehicle body 1 can then be removed from the working space 23 of the robot 11 and a new vehicle body 1 can be fed in for processing.

A TCP/IP interface, which permits a high data rate, is advantageously used for the purpose of communication between the evaluation unit 20 of the sensor system 13 and the control unit 12 of the robot 11. Such a high data rate is necessary to be able to perform closed-loop control of the entire system (sensor system/robot) in six degrees of freedom with eight individual sensors 14′ using the interpolation cycle of the robot 11 (typically 12 milliseconds). For less complex closed-loop control problems, i.e. when less stringent requirements are made of the accuracy and there are relatively long closed-loop control times, the closed-loop control can then be implemented by means of a conventional serial interface.

The exemplary embodiment in FIG. 1, in which eight optical distance-measuring sensors (triangulation sensors) 14′, which are directed towards different areas 8 of the vehicle body 1, are used for positioning the vehicle/sensor combination 16, is configured in such a way that the permissible maximum values for the position correction (and thus the maximum permissible spatial difference between the proximity position which is moved to in an open-loop controlled fashion and the preliminary position which is moved to in a closed-loop control fashion) are each 5 mm in translational terms in X, Y and Z and in each of the three spatial angles 1°. This means that the vehicle body 1 has to be fed into the working space 23 of the robot 11 with a higher degree of accuracy than these maximum deviations. Threshold values of 0.1 mm to 0.2 mm for the translational (X, Y, Z) deviation and 0.03° for the rotational deviation have proven suitable abort criteria for the closed-loop control process in the positioning phase.

In the previous description, the specific case of the processing of the tail light portion 2 on a vehicle body 1 was described, with the robot-guided tool/sensor combination 16 being oriented in a highly precise fashion with respect to the adjacent side wall area 7 and the tail light area 3 as reference areas 8. Of course, other vehicle body areas (for example adjacent portion of the trunk, bumper mount, etc.) can also be used as reference areas for orienting the tool/sensor combination 16 with the rear portion 2. Furthermore, the method can be transferred to processing any other vehicle body areas (attachment area for bumper, front module . . . ) which have to be processed in a precisely positioned fashion relative to a reference area 8. Of course, the method is not restricted to the processing of vehicle bodies 1 but can also be applied basically to any fabrication problems in which a robot-guided processing tool 9 is to be positioned correctly with respect to a reference area 8 of a work piece.

Furthermore it is possible to use the same robot-guided processing tool 9 to process the tail light areas 3 of different types of vehicle body which may be very different in terms of their geometric configuration (shape and position of the reference areas 8, number and position of the connection areas 4 etc.). In this case, as well as the sensors 14 (which are used for positioning the tool/sensor combination 16 with respect to the first vehicle body type 1) the sensor system 13 comprises further sensors 14″ which are used to position the tool/sensor combination 16 with respect to the reference areas of the second vehicle body type; this second set of sensors 14″ is indicated by dashed lines in the schematic illustration in FIGS. 4a to 4d. The sensors 14″ which are used for positioning the tool/sensor combination 16 with respect to the second vehicle body type may differ greatly from the sensors 14 in terms of their number, their spatial orientation, their measuring principle etc. If a vehicle body 1 of the first type is fed to the working space 23, the tool/sensor combination 16 is moved out of the return movement position 22 into the proximity position 24 which is described above and in which the sensors 14 are directed towards the reference areas 8 (as shown in FIG. 4b); the subsequent positioning process uses the measured values of the sensors 14 to move the tool/sensor combination 16 into the preliminary position 18 (see FIG. 4c) after which the processing phase corresponding to the first vehicle body type is run through. If, on the other hand, a vehicle body of the second type is fed to the working space 23, the tool/sensor combination 16 is moved out of the return movement position 22 into a proximity position (not shown in FIG. 4b) in which the sensors 14″ are directed towards the relevant reference areas of the second vehicle body type, and in the subsequent positioning process the measured values of the sensors 14″ are used to move the tool/sensor combination 16 into the preliminary position corresponding to this vehicle body type, and the processing phase which corresponds to the second vehicle body type is then run through. The sensor groups 14 and 14″ do not need to be disjunctive here but instead it is perfectly possible to use some of the sensors 14, 14″ for positioning both with respect to the first vehicle body type and with respect to the second vehicle body type.

In addition to the processing of different vehicle body types using a common tool/sensor combination 16 with sensor groups 14 and 14″ it is also possible to process different areas (for example tail light area 3 and attachment area of the bumper) of the same vehicle body type using a common tool/sensor combination 16. The group of sensors 14 is then used for positioning the tool/sensor combination 16 with respect to the reference area 8 of the tail light area 3, while the group of sensors 14″ is used for positioning the tool/sensor combination 16 with respect to the reference area of the bumper and the processing phases which are associated with the different areas are run through in the respective processing phases.

Until now an application case has been considered in which the vehicle body 1 is fed to the working space 23 of the robot 11 using suitable conveying equipment (for example on a conveying carriage on a roller conveyer) but is then removed from the conveying equipment and is therefore in a fixed position with respect to the working space 23 during the positioning of the tools and the processing. However, it is not necessary for the vehicle body 1 to be supported in such a fixed way with respect to the working space 23: the high-speed closed-loop control of the position of the tool which is described above can be modified in such a way that the sensors 14 carry out on-line compensation of changes in position of the vehicle body 1 so that the tool/sensor combination follows the vehicle body 1. In this case, the stamping/punching pince 9′ of the stamping/punching tool 9 is supported in a movable and/or pivotable fashion with respect to the robot's hand 10 so that the stamping/punching pince 9′ can be moved and/or pivoted with respect to the sensor system 13 in an open-loop controlled fashion. Such movable support of the stamping/punching pince 9′ permits the processing phase (section III) to be carried out in such a position of the tool/sensor combination 16 that the sensor system 13 is oriented towards the reference area 8 of the vehicle body 1 independently of the progress of the processing operation. Since the sensor system 13 is oriented towards the reference area 8 of the vehicle body 1 during the entire processing phase, changes in position and orientation of the vehicle body 1 can be detected in a process-accompanying fashion, and the position and orientation of the tool/sensor combination can then be maintained with respect to the (moving) vehicle body 1 by applying the abovementioned closed-loop control method in a process-accompanying fashion in a preliminary position 18 so that the tool/sensor combination follows the movements of the vehicle body 1. As a result, the vehicle body 1 does not need to be clamped in a fixed fashion during the positioning and processing operation but rather can move, for example by being conveyed further on the assembly line) with respect to the robot 11 (which is possibly also moved at the same time). The only requirement for this is that changes in the relative position between the vehicle body 1 and robot 11 take place more slowly than the measurement and closed-loop control of the position of the tool/sensor combination with respect to the vehicle body 1.

Other optical sensors, in addition to the (laser) triangulation sensors 14′ described specifically above, can also be used as sensors 14 for sensing the actual position of the tool 9 with respect to the reference area 8. For example, CCD cameras which measure over an area may be used as sensors, it being possible to generate the spatial positions of edges, holes etc. as measured variables by means of these sensors (in combination with suitable image evaluation algorithms). In theory, any desired tactile and/or contact-free measuring systems can be used, with the selection of the suitable sensors depending greatly on the respective use.

The invention can be applied both to the robot-guided stamping/punching tools described in the application examples and also to a wide spectrum of robot-guided processing tools. “Robot-guided” tools are to be understood in the context of the present application in a quite general way as tools which are mounted on a multi-axis manipulator, in particular a six-axis industrial robot 11.

A further exemplary embodiment is illustrated in FIGS. 5a, 5b and 6: FIG. 5a shows a plan view of a front end wall 27 of a vehicle body 1 on which a cockpit module 33 is mounted in the course of the assembly of the vehicle (see FIG. 5b). In order to obtain a high quality appearance of the internal area of the vehicle body 1, the cockpit module 33 must be orientated here with respect to the inside 34 of the driver's doors 31, so that the gap dimensions and joint dimensions between the cockpit module 33 and the adjacent areas 35 of the inside 34 of the doors are optimized. In order to mount the cockpit module 33 in a precisely positioned fashion, bolts 28 are provided in side areas 30 of the end wall 27 as adjustment elements which define the position of the cockpit during the final assembly. These bolts 28 are introduced into the vehicle body 1 at a time at which the doors 31 are already installed and are oriented with respect to the adjacent areas 32 of the outer skin of the vehicle (see FIG. 6). The bolts 28 are attached to the end wall 27 using bolt welding.

In order to orient and attach the bolt 28 in a precisely positioned fashion a tool/sensor combination 116 (illustrated schematically in FIG. 6) is used which is attached to the hand 110 of an industrial robot 111. The tool/sensor combination 116 comprises a linkage 115 to which two bolt welding devices 109 and a sensory system 113 with two optical sensors 114 are attached. The sensors 114 are oriented towards the linkage in such a way that they can record measured values of the side areas 30 of the end wall 27 and of the adjacent areas 35 of the doors 31 if the tool/sensor combination 116 is, as shown in FIG. 6, moved towards the end wall 27 in the interior of the vehicle body 1.

In order to “train” this processing task, at first a setup phase is run through (in a way which is analogous to the method described above): the tool/sensor combination 116 is oriented here in the preliminary position (shown in FIG. 6) with respect to the end wall 27 (“master”) vehicle body 1′ and measured values of the sensors 114 are recorded in this position of the tool/sensor combination 116. Further measurements, for which the tool/sensor combination 116 is changed systematically along known paths, are then carried out. The Jacobi matrix of the tool/sensor combination 116 is then calculated from the measured data and stored in an evaluation unit of the sensor system 113. The sections of the movement path of the tool/sensor combination 116 which are to be run through in an open-loop controlled fashion are then trained (interactively or off-line).

In the working phase, vehicle bodies 1 are fed to the robot 111 and the movement path which is generated in the setup phase is run through for each vehicle body 1. In the process, the tool/sensor combination is firstly positioned, by means of a closed-loop control process, in the preliminary position with respect to the end wall 27 in which the tool/sensor combination 116 is oriented in an optimum way with respect to the areas 35 of the inside 34 of the door which are adjacent to the end wall 27, and this closed-loop control process proceeds in an analogous fashion to the positioning phase (movement path section II) described above. Starting from this preliminary position, a processing phase (movement path section III) is then run through, in the course of which the tool/sensor combination 116 is moved against the end wall 27 so that the bolts 28 can be placed in the positions lying opposite them on the side areas 30 using the bolt welding devices 109. The “forming of the connection area” thus corresponds in this case to the precisely positioned setting of the bolts 28 in the side area 30. The position of the bolts 28 is thus oriented in an “optimum” fashion with respect to the adjacent inner areas 35 of the driver's doors 31. This ensures that the cockpit module 33 which is plugged onto the bolts 28 within the scope of the final assembly has the desired gap dimension and junction dimensions with respect to the inner walls 35 of the door.

1-12. (canceled)

13. A method for producing a connection area on a work piece, the connection area being positioned precisely with respect to a reference area on the work piece, a robot-guided processing tool being used for shaping the connection area, the processing tool forming a tool/sensor combination with a sensor system having at least one sensor and being fixedly connected to the tool, the method comprising:
moving the tool/sensor combination during during a positioning phase from a proximity position independent of a position of the work piece in a working space of a robot into a preliminary position, the tool/sensor combination in the preliminary position being oriented in a precisely positioned fashion with respect to a reference area of the tool, and
guiding the tool/sensor combination, in a processing phase, from the preliminary position along a processing path under control of the robot, the connection area being formed on the work piece during the course of the processing path the connection,
the moving step including running through an iterative closed-loop control process to move the tool/sensor combination into the preliminary position, the iterative closed-loop control process including:
generating an actual measured value of the at least one sensor,
comparing the actual measured value with a setpoint measured value generated within the scope of a setup phase,
calculating a movement vector of the tool/sensor combination from a difference between the actual measured value and the setpoint measured value using a Jacobi matrix calculated within the scope of the setup phase, and
displacing the tool/sensor combination using the movement vector.

14. The method as recited in claim 13 wherein the iterative closed-loop control process is completed if either the difference between the setpoint measured value and the actual measured value lies below a predefined threshold value, or a reduction brought about in the difference during successive iteration steps lies below a predefined threshold value.

15. The method as recited in claim 13 wherein the positioning phase and the processing phase take place in an overlapping fashion with respect to one another.

16. The method as recited in claim 13 wherein a TCP/IP interface is used for communication between an open-loop control device of the robot and an evaluation unit of the sensor system.

17. The method as recited in claim 13 wherein measured values of different individual sensors of the sensor system are used for position control for positioning the tool/sensor combination with respect to different vehicle body types or with respect to different reference areas of a same vehicle body type.

18. The method as recited in claim 13 wherein the connection area is a tail light area of a vehicle body.

19. The method as recited in claim 13 wherein the connection area are welds of adjustment elements for orienting a cockpit to a front end wall of a vehicle body.

20. The method as recited in claim 13 wherein the work piece is a vehicle body.

21. A device for producing a connection area on a work piece, the device comprising:
a processing tool guided using a robot;
a sensor system fixedly connected to the processing tool and having at least one sensor;
a control device for controlling the robot and the processing tool;
an evaluation unit for evaluating measured values of the sensor system;
at least one of the sensors being a metrically noncalibrated sensor.

22. The device as recited in claim 21 wherein the processing tool is a stamping or punching tool.

23. The device as recited in claim 21 wherein the processing tool is a bolt welding device.

24. The device as recited in claim 21 wherein the at least one sensor is a triangulation sensor measuring points.

25. The device as recited in claim 21 wherein the at least one sensor is an optical sensor measuring over an area.

26. The device as recited in claim 21 wherein the device is a vehicle body processing device.
